(19) United States
(12) Patent Application Publication
(10) Pub. No.: US 2016/0358424 A1
(43) Pub. Date: Dec. 8, 2016

(54) Apparatus for Playing a Game

(71) Applicant: HIPPODROME CASINO LIMITED, London (GB)

(72) Inventor: Simon James Thomas, London (GB)

(21) Appl. No.: 15/121,368

(22) PCT Filed: Feb. 25, 2015
(86) PCT No.: PCT/GB2015/050545

§ 371 Date: Aug. 24, 2016

(30) Foreign Application Priority Data
Feb. 25, 2014 (GB) 1403313.8

(51) Int. Cl. G07F 17/32

(52) U.S. Cl. CPC G07F 17/3272; G07F 17/3209; G07F 17/3211; G07F 17/3244; G07F 17/3225

(57) ABSTRACT

The present invention relates to apparatus for playing a game and, in particular, to apparatus for playing a game of chance where a stake may be gambled. The apparatus comprises a game control device or game controller, at least one primary player terminal comprising a game play starting apparatus and/or input device, and at least one secondary player terminal comprising a game play opt-in and/or opt-out selection apparatus and/or input device.

### BACKGROUND OF THE INVENTION

The present invention relates to apparatus for playing a game and, in particular, to apparatus for playing a game of chance where a stake may be gambled.

Manual, semi-automated and automated games of chance are well known in the art and are widely available in a number of different game formats and themes. Manual games of chance where money is staked include, inter alia, card games such as Blackjack and other games such as Roulette. Certain of these traditionally manual games have also been developed to exist in semi-automated formats. Automated games of chance where a stake (typically money) is gambled are commonly referred to as gaming machines, amusement-with-prizes machines (AWPs) or fruit machines. These gaming machines are provided for the purposes of entertainment, recreation and sport, and are sited at venues such as leisure centres, public houses, amusement arcades, clubs, bingo halls and casinos. In particular, gaming machines are sited in considerable numbers at dedicated gaming centres such as bingo halls and casinos.

The apparatus of the present invention is of particular utility in new game formats developed by the applicant which may be well suited to, or related to, known games, such as those played manually (card games such as Blackjack, and other games such as Roulette) or on gaming machines, amusement-with-prizes machines (AWPs) or fruit machines. The foregoing are examples only, and other games and game formats can also be realised and played using the apparatus of the present invention.

It is well known in the art, for example, for fruit machines to adopt a game format where either mechanical reels are used, or separate images of indicia are generated optically or electronically, to display an array of indicia arranged in three separate rows, with each row comprising either three or five indicia. The indicia array is generated randomly by the apparatus in each and every turn of play. Wins can be determined by vertical and diagonal play-lines as well as by horizontal play-lines. Known game formats also permit use of a “nudge” and/or “hold” function to enable a player of the game to manipulate the position in the array of an individual indicia, as is well known in the art.

Card games, on the other hand, are more usually played manually using one or more standard decks of cards in a manner well known in the art. A playfield may additionally be employed for certain card game formats. Numerous card game formats and themes exist and are well known in the art. One example, Blackjack, takes the form of a card game between a dealer and one or more players. The player(s) is dealt an initial two-card hand by the dealer and adds together the face value of his/her individual dealt cards. Kings, Queens and Jacks have a value of 10, an Ace has a value of 1 or 11, and all other cards take the numeric value of the card. After receiving his/her initial two cards, the player(s) has the option of not having any further cards dealt (“standing”), or of having one or more additional cards dealt (“hitting”). The player or the dealer wins by having a total hand value of 21 or by having the highest hand value that is less than 21. Having a hand value greater than 21 (“going bust”) results in a loss, and so a player may win by having a total hand value equal to or less than 21 if the dealer “goes bust”.

The game of Roulette takes the form of a Roulette table having a Roulette wheel and a playfield. A croupier oversees and manages the game. In each turn of play, players of the game are invited to place a stake, typically in the form of a “chip”, on the playfield so as to bet on a particular outcome or range of outcomes of the Roulette wheel. The Roulette wheel is spun, a ball released, and the ball comes to rest in one of a number of possible positions provided on the Roulette wheel, thus determining the game outcome in that turn of play. The croupier “banks” the stakes of losing players and pays out wins from the bank to winning players of the game. A typical Roulette wheel has thirty seven segments numbered “0” to “36”, with numerals “1” to “36” positioned on alternating red and black coloured segments and the numeral “0” occupying a green segment. The playfield comprises a green baize marked with a grid of play spaces having not only the corresponding thirty seven possible number outcomes, but also having play spaces specifically assigned with “odd”, “even”, “red”, “black”, “1st 12”, “2nd12”, “3rd12” designations to enable a player to place a stake on a more likely outcome (albeit with a reduced payout corresponding to the more favourable odds). A stake placed on a single number only is termed a “straight up” bet. A stake placed on combinations of play spaces is termed a “party bet”.

It is known in the art to provide some degree of automation of the game of Roulette. For example, in GB 2284499 A of McNally Gaming Limited, there is disclosed a self contained coin operated gaming machine having a Roulette wheel behind a glass screen. Optical sensors are provided for determining the position of the wheel as it rotates. Means is also provided for detecting when a ball has settled in a segment of the wheel, thus determining the number selected by the ball and whether a player of the game has preselected that number for play. If so, the player is a winner and a prize is awarded.

### SUMMARY OF THE INVENTION

The present invention is concerned with improving upon traditional apparatus for playing games of chance and addresses the limitations of the prior art. In particular, the applicant has developed new apparatus which enables a player of a game to use the apparatus of the present invention to “play behind” another player or players. The term “playing behind” is used to refer to the situation where a “first” player (also known as a “primary player”) of a game plays the game in a usual manner, and a “second” (or more) player(s) (also known as a “secondary player”) simply copies the first player by replicating the game play, selection and/or other manner in which the first player is playing the game (but not necessarily replicating the stake or bet which may be for the second player(s) to select, or be limited or controlled by local legislation). The second (or more) player(s) win or lose in the same way as the first player, with any payout being split proportionally dependent upon the stakes or bets placed by the players and/or as limited or controlled by local legislation.

The present invention provides, in a first aspect, apparatus for playing a game comprising:

a game control device or game controller;

at least one primary player terminal comprising a game play starting apparatus and/or input device; and

at least one secondary player terminal comprising a game play opt-in and/or opt-out selection apparatus and/or input device.

### BRIEF DESCRIPTION OF THE DRAWINGS

Preferred embodiments of the present invention will now be described by way of example only with reference to the accompanying drawings, in which:

FIG. 1 is a schematic view of a first preferred embodiment of apparatus for playing a game according to the present invention, illustrating a plurality of terminals each connected to a central control unit including a visual display unit; and

FIG. 2 is a schematic view of a second preferred embodiment of apparatus for playing a game according to the present invention, illustrating a plurality of terminals each connected to a central control unit as in FIG. 1, but where the control unit does not include a visual display unit.

### DETAILED DESCRIPTION OF THE INVENTION

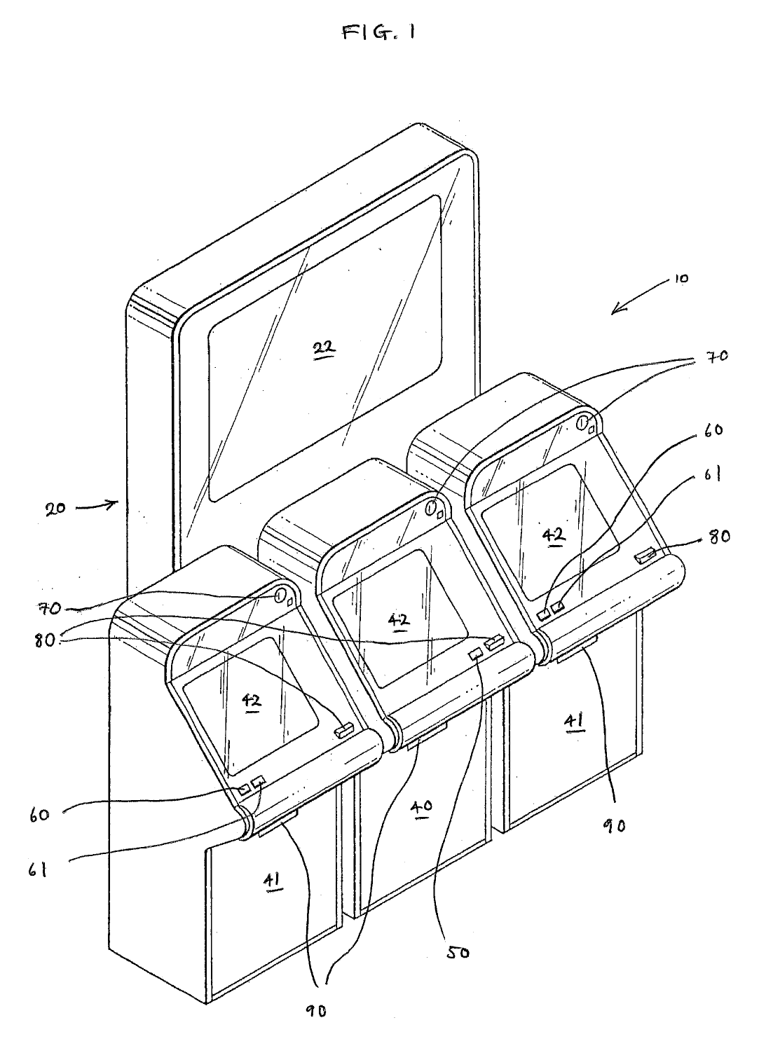

Referring first to FIG. 1, a gaming apparatus 10 according to a first preferred embodiment of the present invention is shown. A central control unit 20 (and referred to herein also as a game control device, a game controller or a game control unit) comprises a visual display unit 22 (optional), programmable electronic processing means, and optional data storage. Three player terminals 40, 41 are shown sited in close proximity (optional) to the central control unit 20, each terminal 40, 41 being of conventional gaming machine construction. Each terminal 40, 41 comprises an interactive visual display unit 42 (optional if the visual display unit 22 is provided), preferably a touch sensitive screen, its own programmable electronic processing means, and optional data storage. A “start” function button 50 may be provided on terminal 40 (and may not be provided on terminal(s) 41, or inactivated in play if it is provided), while “opt-in” and “opt-out” “hard key” function buttons 60, 61 may be provided on terminal(s) 41 (and may not be provided on terminal 40, or inactivated in play if they are provided). Such “hard key” function buttons 50 and 60, 61 are physically present and manually operable buttons. Alternatively, the function of these buttons may be realised via the interactive visual display unit 42 (“soft key” buttons), where provided on each terminal 40, 41 respectively. Each terminal 40, 41 is provided with a form of payment receiving and payment dispensing means. In the embodiment shown, this takes the form of a coin slot 70 and a note acceptor 80 provided for receipt of coins and notes from a player of the game. A payout tray 90 is provided for a player to collect winnings in the form of coins and/or notes paid out directly by the terminal 40, 41. Alternatively, any suitable form of payment receiving and dispensing may be beneficially employed, as described later herein. All terminals 40, 41 are connectable to the central control unit 20 (wired or wireless) so as to permit communication therebetween and, if desired, with one another. Player terminal 40 at least is used by a player of the game in each turn of play, this player being denoted the first (or primary) player and who actually plays the game. One or more of player terminals 41 may be used by additional player(s) of the game in each turn of play, this/these player(s) being denoted the second (or secondary) player(s) who simply “play behind” the first player.

The central control unit 20 comprises programmable electronic processing means accessible by each of the terminals 40, 41 of the gaming apparatus 10. The electronic processing means of the central control unit 20 has overall control of the gaming apparatus 10 and functions as at least one randomiser (random number/indicia generator) to generate random indicia in each turn of play of the game.

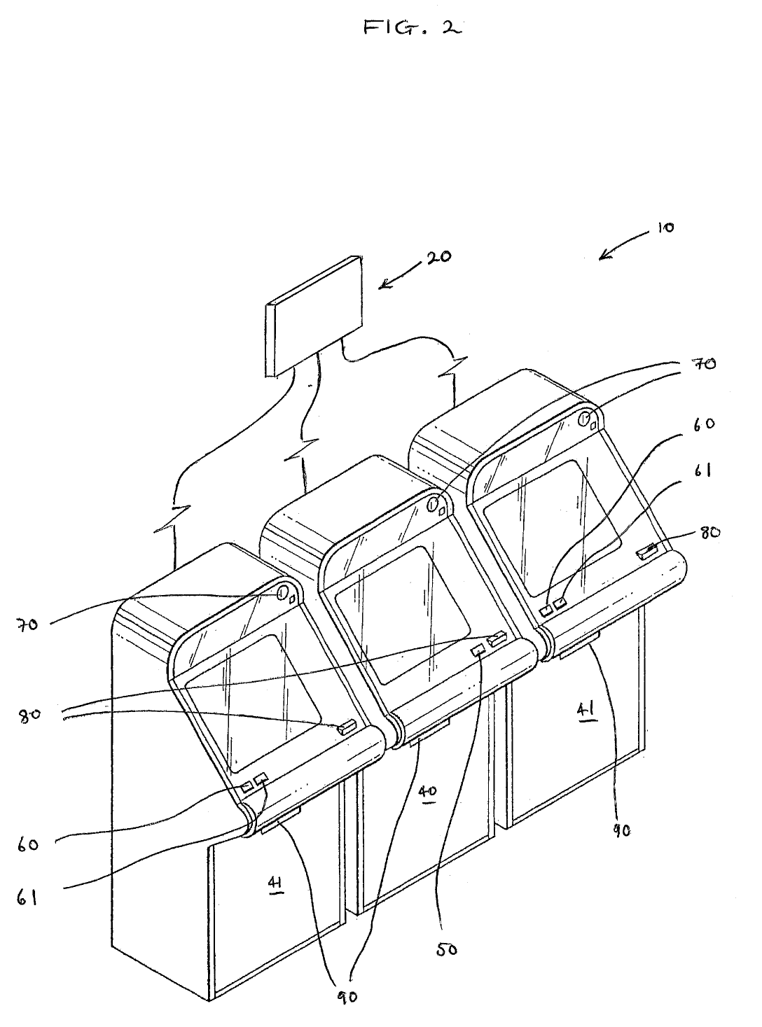

In FIG. 2, the optional visual display unit 22 is not provided. In this second embodiment, the interactive visual display unit 42 of each terminal 40, 41 provides the necessary visual data.

In an alternative embodiment (not shown), the visual display unit 22 is not optional but required. Instead, each interactive visual display unit 42 of each terminal 40, 41 is not provided and the necessary visual data for the game is provided by the visual display unit 22. In such an embodiment, each terminal 40, 41 must be positioned so as to have sight of the visual display unit 22. To provide for player input and/or interaction, the “start” function button 50 is provided on terminal 40 (and may not be provided on terminal 41, or inactivated in play if it is provided), while “opt-in” and “opt-out” function buttons 60, 61 are provided on terminals 41 (and may not be provided on terminal 40, or inactivated in play if they are provided).

The electronic processing means of the central control unit 20 generates the necessary signals for the visual display unit 22 to display the game. A particular indicia or range of indicia from a predefined set of indicia particular to the game being played are reproduced.

In a yet further embodiment (not shown), a common design of player terminal is employed having both the “start” function button 50 and the “opt-in” and “opt-out” function buttons 60, 61. This common design of player terminal avoids the necessity to have bespoke terminals 40, 41. Instead, the requirement to have a player terminal used and controlled by a first player with the “start” function button 50 enabled (and the “opt-in” and “opt-out” function buttons 60, 61 disabled), and the second and further player terminals used and controlled by a second or more players with the “opt-in” and “opt-out” function buttons 60, 61 enabled (and the “start” function button 50 disabled) can be controlled by the electronic processing means accessible by each player terminal of the gaming apparatus 10. As such, a common design of player terminal can be programmed and/or controlled to permit use by either a first (primary) player or a second (secondary) player or players. For example, the player terminal may be a purpose built player terminal, or may be embodied in any one or more of a computer, a laptop, a tablet, a personal digital assistant (PDA), a cellular telephone, a television, a visual display unit or other electronic processing means. In the latter example, the “hard key” functions may be realised by way of a keyboard, while the “soft key” functions may be realised via touch screen or cursor/icon manipulation/selection.

In a first example of game play relating to a fruit machine format, the gaming apparatus 10 according to the present invention has a randomiser having or simulating a set of reels associated therewith. The randomiser may be a conventional unit well known in the art. The randomiser is used to generate a random combination of indicia in each and every turn of play. For example, this may comprise or simulate three or five reels having a common axis about which each can (or appear to) rotate. The circumferential edge of each reel (or simulated reel) is provided with a plurality of indicia selected from a set corresponding to the particular game format or theme. The indicia set may comprise, for example, representations of fruit.

The electronic processing means cooperates with the payment receiving means 70, 80 and registers when a player or players of each terminal has deposited the necessary stake funds for at least one turn of play of a game.

The visual display units 22, 42 indicate to player(s) the status of the gaming apparatus 10, for example, the level of credit remaining, the winnings banked and which of the terminals 40, 41 is/are selected for play. Soft and/or hard buttons are used to play the game in each turn of play. However, importantly, only the first player of terminal 40 has access to a functioning “start” button 50 to commence play of the game in each turn of play. The second and other player or players, if any, must “opt-in” or “opt-out” using buttons 60, 61 on terminals 41, prior to the first player operating the start button if they wish to play behind the first player in that turn of play. The second and other player or players, if any, do not necessarily replicate the stake or bet of the first player since this may not be desired, or may be limited or controlled by local legislation. Where a different stake or bet is desired or required to be entered by the second and other player or players, this can be effected using either soft and/or hard buttons as may be provided on the terminal (the soft buttons being provided by the interactive visual display unit 42). The second (or more) player(s) win or lose in the same way as the first player, with any payout being split proportionally dependent upon the stake or bet placed and/or as limited or controlled by local legislation.

When the first player begins a turn of play by depressing the “start” button 50, an amount equal to that incurred by the first player's stake is debited from the first player's credit balance (as is the stake of each of the second and other player(s) opted-in for that turn of play from their respective credit balance), and the remaining credit balance(s) indicated on the visual display units 22, 42. A second and other player need not “opt-in” in each turn of play.

In every turn of play, the randomiser is activated by the pressing of the “start” button 50 and the set of reels (or simulated reels) are spun about their common axes and subsequently come to rest (or simulated rest) so as to generate a random combination of indicia which is determined by the position of the indicia of the reels (or simulated reels) relative to a fixed reference point. A player is a winner if the combination of indicia generated by the randomiser and its associated set of reels (or simulated reels) selected for play in that turn of play matches a winning combination issued or published by the game organiser or promoter.

Winning combinations issued or published by the game organiser or promoter can be programmed into the gaming machine apparatus 10 and in the case of a winning match, the corresponding cash prize is credited to the player(s) and indicated accordingly by the respective “bank” display of visual display units 22, 42. A player may cash his or her winnings at any time, whereupon the winnings are dispensed by the associated payment dispensing means, e.g. such as the payout tray 90.

It is a feature of certain game formats or themes that in a turn of play the player may be invited to participate in that turn of play, in a way which influences the combination of indicia generated by the randomisers. Typically, this participation involves the player by inviting activation of one or more of the function buttons associated one each with one of the reels (or simulated reels) of the randomiser. The buttons permit, for example, a reel to be “held”, i.e. refrained from rotating in a turn of play, or be to “nudged” i.e. rotated in either direction relative to the other reels in the same set, functions which are well known in the art of gaming machines. The buttons providing the “nudge” or “hold” features may be randomly enabled and are only enabled for the first player.

In a second example of game play relating to a Roulette game format, the electronic processing means of the central control unit 20 generates the necessary signals for the visual display units 22, 42 to display a playfield for placing of a stake and at least part of a “Roulette wheel”. The playfield displayed on the visual display unit 42 of terminal 40 is interactive and may be used by the first player to place his or her stake. The Roulette wheel is in fact the randomiser of the gaming apparatus 10 having a predefined set of indicia. In this preferred embodiment the predefined set of indicia is that of a standard Roulette wheel, and corresponds to the playfield displayed. The Roulette wheel displayed is dynamic in the sense that the electronic processing means can generate signals which cause the visual display units 22, 42 to simulate both a spinning Roulette wheel and a Roulette wheel at rest. The winning indicia of the roulette wheel is displayed on the visual display units 22, 42, preferably identified by an electronic representation of a ball or other indicia coming to rest or appearing in a ball position adjacent the winning indicia.

The interactive visual display unit 42 displays graphics of the playfield under the control of the electronic processing means of the terminal 40 and/or the electronic processing means of the central control unit 20 and is responsive to tactile inputs from the first player of the game. These inputs from the first player can be relayed from the terminal 40 to the central control unit 20. As in the previous fruit machine example, the payment receiving means 70, 80 registers when a player or players of each terminal 40, 41 has deposited the necessary stake funds for at least one turn of play of a game. The first player may place stakes on the playfield simply by touching the interactive visual display unit 42 in a relevant location so as to place a chip on a play space of the playfield, either on a single indicia (i.e. a ‘straight up’ bet) or on an intersection or side wall of a play space (i.e. a ‘party’ bet). The stakes placed by the first player may be subject to rules policed by the terminal 40 and/or central control unit 20 which stipulate the maximum bet on a winning chance, as is known in the traditional game of Roulette. The first player may add to, delete from, or amend any bets placed on the playfield simply by touching the interactive visual display unit 42 to toggle between selections. Touching the interactive visual display unit 42 causes a selection to be made and touching the screen again causes a de-selection (“soft key” operation). Alternatively, the first player can use the “hard key” function buttons (which could include “clear all bets”, “clear last bet” and “repeat bet” buttons, each of whose function is self-explanatory).

The second and other player or players, if any, must “opt-in” or “opt-out” using buttons 60, 61 on terminals 41, prior to the first player operating the start button if they wish to play behind the first player in that turn of play. The second and other player or players, if any, must “opt-in” or “opt-out” using buttons 60, 61 on terminals 41, prior to the first player operating the start button if they wish to play behind the first player in that turn of play. The second and other player or players, if any, do not necessarily replicate the stake or bet of the first player since this may not be desired, or may be limited or controlled by local legislation. Where a different stake or bet is desired or required to be entered by the second and other player or players, this can be effected using either soft and/or hard buttons as may be provided on the terminal (the soft buttons being provided by the interactive visual display unit 42). The second (or more) player(s) win or lose in the same way as the first player, with any payout being split proportionally dependent upon the stake or bet placed and/or as limited or controlled by local legislation.

The visual display units 22, 42 indicate to player(s) the status of the gaming apparatus 10, for example, the level of credit remaining, the winnings banked and which of the terminals 40, 41 is/are selected for play. Soft and/or hard key buttons are used to play the game in each turn of play. However, importantly, only the first player of terminal 40 has access to a functioning “start” button 50 to commence play of the game in each turn of play. The second and other player or players, if any, must “opt-in” or “opt-out” using buttons 60, 61 on terminals 41, prior to the first player operating the start button if they wish to play behind the first player in that turn of play.

When the first player begins a turn of play by depressing the “start” button 50, an amount equal to that incurred by the first player's selection is debited from the player's first player's credit balance (as is that of each of the second and other player(s) opted-in for that turn of play from their respective credit balance), and the remaining credit balance(s) indicated on the visual display units 22, 42. A second and other player need not “opt-in” in each turn of play.

In every turn of play, the randomiser is activated by the pressing of the “start” button 50 and the Roulette wheel is spun and subsequently comes to rest so as to generate a random indicia which is determined by the position of the ball. A player is a winner if the characteristics of the indicia generated by the randomiser and its associated Roulette wheel in that turn of play matches a winning combination staked on the playfield by the first player.

In a third example of game play relating to a Blackjack card game format, the electronic processing means of the central control unit 20 generates the necessary signals for the visual display units 22, 42 to display relevant aspects of play of the game and for placing of a stake. This will include the card hand initially dealt to the first player by the dealer, cards dealt subsequently to the first player by the dealer at the first player's request, and the card hand of the dealer at the appropriate times during play. The visual display unit 42 of terminal 40 is interactive and may be used by the first player to place his or her stake, and may be used to play the game. The card hand is in fact the output from the randomiser of the gaming apparatus 10, having a predefined set of indicia. In this preferred embodiment the predefined set of indicia is that of a standard deck of cards, and corresponds to the indicia displayed. The card hand displayed is dynamic in the sense that the electronic processing means can generate signals which cause the visual display units 22, 42 to simulate both an initially dealt card hand, and cards dealt subsequently, both of the first player and, at an appropriate time, of the dealer. The winning card hand may be displayed on the visual display units 22, 42.

The interactive visual display unit 42 displays graphics of the game under the control of the electronic processing means of the terminal 40 and/or the electronic processing means of the central control unit 20 and is responsive to tactile inputs from the first player of the game. These inputs from the first player can be relayed from the terminal 40 to the central control unit 20. As in the previous fruit machine example, the payment receiving means 70, 80 registers when a player or players of each terminal 40, 41 has deposited the necessary stake funds for at least one turn of play of a game. The first player may place a stake simply by touching the interactive visual display unit 42 in a relevant location so as to record a stake placed. The stake(s) placed by the first player may be subject to rules policed by the terminal 40 and/or central control unit 20 which stipulate the maximum bet on a winning chance. The first player may add to, delete from, or amend any stakes placed simply by touching the interactive visual display unit 42 to toggle between selections. Touching the interactive visual display unit 42 causes a selection to be made and touching the screen again causes a de-selection (“soft key” operation). Alternatively, the first player can use the “hard key” function buttons (which could include “clear all bets”, “clear last bet” and “repeat bet” buttons, each of whose function is self-explanatory).

The second and other player or players, if any, must “opt-in” or “opt-out” using buttons 60, 61 on terminals 41, prior to the first player operating the start button if they wish to play behind the first player in that turn of play. The second and other player or players, if any, do not necessarily replicate the stake or bet of the first player since this may not be desired, or may be limited or controlled by local legislation. Where a different stake or bet is desired or required to be entered by the second and other player or players, this can be effected using either soft and/or hard buttons as may be provided on the terminal (the soft buttons being provided by the interactive visual display unit 42). The second (or more) player(s) win or lose in the same way as the first player, with any payout being split proportionally dependent upon the stake or bet placed and/or as limited or controlled by local legislation.

The visual display units 22, 42 indicate to player(s) the status of the gaming apparatus 10, for example, the level of credit remaining, the winnings banked and which of the terminals 40, 41 is/are selected for play. Soft and/or hard key buttons are used to play the game in each turn of play. However, importantly, only the first player of terminal 40 has access to a functioning “start” button 50 to commence play of the game in each turn of play. The second and other player or players, if any, must “opt-in” or “opt-out” using buttons 60, 61 on terminals 41, prior to the first player operating the start button if they wish to play behind the first player in that turn of play.

When the first player begins a turn of play by depressing the “start” button 50, an amount equal to that incurred by the first player's selection is debited from the player's first player's credit balance (as is that of each of the second and other player(s) opted-in for that turn of play from their respective credit balance), and the remaining credit balance(s) indicated on the visual display units 22, 42. A second and other player need not “opt-in” in each turn of play.

In every turn of play, the randomiser is activated by the pressing of the “start” button 50 and the Blackjack card game commences, generating an initial hand dealt by the dealer. A first player is a winner if the characteristics of the indicia generated by the randomiser and its associated card hand in that turn of play beats that of the dealer.

It will be appreciated that changes to the number and/or functions of the buttons and displays provided may be made to the gaming machine apparatus of the present invention to cater for the numerous different game formats and themes possible, as well as the desired form of apparatus to implement the invention.

In each embodiment of the present invention the second or other player of the gaming apparatus in each turn of play chooses to “opt-in” or “opt-out” for the purposes of gambling his or her stake dependent upon how the first player fares. The second or other player can choose to play in one turn of play, or not. However, in each turn of play, the first player always plays. A second or other player may find, therefore, that he or she has not elected to “opt-in” to a winning game by the first player, or that he or she has not elected to “opt-in” to a losing game by the first player.

Whilst in the preferred embodiments described above the means for accepting and issuing payment comprises a coin and note receiving/issuing apparatus, it will be appreciated that any means of accepting and issuing credit well known in the art may be employed in a gaming machine apparatus according to the present invention. For example, a payment accepting/issuing means may be provided to accept/issue tokens, printed barcodes, notes, or to debit/credit credit cards or charge cards. A further example of a system for handling the accepting and issuing of payments well known in the art is a Ticket In Ticket Out (TITO) system. Alternatively, the gaming machine apparatus may be linked to a central electronic memory holding account details of a player and a player may identify him or herself to the gaming machine apparatus by, for example, entering a personal identification number, and in each turn of play the gaming machine apparatus adjusts the personal account of the player stored in the electronic memory.

Additionally, a portable hand held unit with electronic processing means, card and/or paper receipt readers and a printer may be provided for use by a game operator or manager in order to produce a credit slip for winnings over a predetermined limit, or to accept credit from a player. The portable unit is connectable to a terminal via an RS232, USB or similar type wire connection, or via an infra-red or other wireless communications link for data exchange therebetween. This portable unit may be provided for convenience, safety/security reasons or to comply with legislative requirements.

It will be appreciated that the preferred embodiments of gaming apparatus 10 described in detail above may be varied in many respects, certain of which will now be described by way of example. In this regard, the scope of the invention is that as set out in the appended claims. In addition, it is to be noted that differing legislation applies in the various jurisdictions in which the apparatus of the present invention may be employed. Consequently, the stakes placed, odds available and the frequency of game play in particular, inter alia, will be dictated by the relevant legislation in force and programmed accordingly. For example, in the UK at the time of writing, the gaming apparatus of the present invention can allow a stake of up to £5 with a jackpot of up to £10,000.

Customised predefined indicia set or sets may be employed in the gaming apparatus 10. Furthermore, in yet further embodiments of the present invention the randomiser, indicia set(s) and playfield(s) where used may take a form more suitable for other game formats. For example, one such alternative game format requires the randomiser to take the form of a dice or die (or sets thereof) bearing standard game and/or bespoke indicia. Another example is an alternative game format which requires the randomiser to take the form of one or more decks of cards bearing standard game and/or bespoke indicia. The playfield(s), where used, will bear appropriate markings reflecting the particular game format being played and the betting/playing spaces corresponding at least to each of those individual indicia borne by the dice or die or card or cards and may also bear further betting/playing spaces (e.g. such as ‘odd’, ‘red’, ‘king’, ‘diamond’ etc. depending on the indicia set employed) to provide the option of party bets.

In addition, further betting opportunities may be presented to a player of the gaming apparatus 10. In this case, a first player of the game may bet a stake on a particular result, event, or set of results or events. As such a combination is far more unlikely, a high value prize may be offered by the operator for any such winning bet, typically a large cash sum or a car, for example.

Whilst in the preferred embodiments described, the gaming apparatus 10 comprises a central control unit and three terminals each connected to the central control unit, this is of course only exemplary. The game apparatus 10 is modular in nature and so it is possible that any plural number of terminals may be connected to the central control unit, from two to any number. Indeed, each terminal does not have to be located at the same site as the central control unit. One or more terminals may be located remotely at a different site and connected to the central control unit via a communications network such as the Internet, an intranet, or by Wi-Fi, for example. Alternatively, the central control unit may be provided in one or more of the terminals, or remotely, with a suitable communications network provided to/from other terminals.

Furthermore, with the availability of the Internet and Wi-Fi, it will be appreciated that a player may use his or her own personal computer, laptop, tablet, personal digital assistant (PDA), cellular telephone, smart phone, television, visual display unit or other electronic processing means as a terminal in which case software may be downloaded from the central control unit, a game operator's website, or may be purchased separately for uploading on to the device in question in order that it has the full functionality of a terminal. Indeed, the central control unit may be provided in one or more of these devices.

Whilst the visual display units are preferably of the plasma and TFT touch sensitive types respectively, it will be appreciated that any form of visual display unit may be alternatively or additionally employed. Examples of such display units include, inter alia, cathode ray tubes, liquid crystal displays (LCDs), light emitting diodes (LEDs) and projectors.

It will be appreciated that wire free communication between the central control unit, terminals and any associated apparatus is possible, rather than via a hard wired connection. This may be achieved using infra-red, radio, cellular, Wi-Fi, Bluetooth or any other such wire free communication medium or protocol.

The electronic processing means in each of the central control unit and each terminal are programmable and data storage capability is additionally provided. Game software and game play data may be stored by either or both of the central control unit and each terminal. Different game software is available so that different game formats and themes may be played on the game apparatus 10 of the present invention. In particular, different versions of the game software are available, each of which are produced to comply with the different gaming legislation and regulations applicable to the different sites and countries in which the game apparatus 10 is sited and operated. The data storage facility database in each of the central control unit and each terminal is used by operators of the game apparatus 10 in order to obtain reports on all aspects of game play such as, for example, cash in, cash out, number of games played, number of games played per player in each turn of play, and win history.

As mentioned above, the present invention provides apparatus for playing a manual, semi-automated, or fully-automated game of chance where a stake may be gambled. Whilst in the preferred embodiments described above in detail parts of the apparatus such as the reels, Roulette wheel and cards, for example, are simulated in electrical/electronic form, the present invention is not limited to this format and can instead take the form of a traditional or bespoke physical apparatus. For example, the present invention may take the form of a physical reel array and a terminal to play, of a physical Roulette wheel or wheels and a terminal for use by a player to place bets on a playfield or playfields, or of real physical cards. The playfield(s), where used, may be simply represented electronically on the terminal and made available for use by the player, or the terminal may be used by a player to indicate to a croupier, dealer or other person the bet or bets to be staked. Such a terminal may be located in close proximity to the physical reel array, Roulette wheel(s) and/or playfield(s) and/or card dealer, or alternatively, at a remote location. In any case, the terminal may be supplied by live video feed from, or a camera link with, the physical apparatus. Also, whilst in the main the apparatus described in detail above is automated as far as possible, this level of automation may be detrimental to a player's interest in a particular game format or may be precluded by legislation. In such a case, user interaction can be increased by requiring more manual inputs by the player or players of the game. For example, a player of the game may be required to spin the physical reel array or physical Roulette wheel or wheels by hand or receive the cards dealt, or start the electronic simulation of such reel arrays or Roulette wheels or dealing of cards by depressing a button on the terminal or touching an area of the screen.

It will be appreciated that the above description is not limiting and that the game apparatus, game format, playfield where used, and indicia sets can all be varied so as to provide a vast array of games which may be played by a player at multiple sites or indeed a across the world by remote access. This functionality together with the particular inventive concept as set out in the appended claims gives rise to a new gaming experience.

Each feature disclosed in this specification (including the accompanying claims and drawings), may be replaced by alternative features serving the same, equivalent or similar purpose, unless expressly stated otherwise. Thus, unless expressly stated otherwise, each feature disclosed is one example only of a generic series of equivalent or similar features. In addition, all of the features disclosed in this specification (including the accompanying claims, abstract and drawings), and/or all of the steps so disclosed, may be combined in any combination, except combinations where at least some of such features and/or steps are mutually exclusive. Accordingly, while many different embodiments of the present invention have been described above, any one or more or all of the features described, illustrated and/or claimed in the appended claims may be used in isolation or in various combinations in any embodiment. As such, any one or more feature may be removed, substituted and/or added to any of the feature combinations described, illustrated and/or claimed. For the avoidance of doubt, any one or more of the features of any embodiment may be combined and/or used separately in a different embodiment with any other feature or features from any of the embodiments.

1. Apparatus for playing a game comprising:
a game control device or game controller;
at least one primary player terminal comprising a game play starting apparatus and/or input device; and
at least one secondary player terminal comprising a game play opt-in and/or opt-out selection apparatus and/or input device.

2. Apparatus for playing a game as claimed in claim 1, wherein:
the at least one primary player terminal further comprises communication apparatus for communication with the game control device or game controller and/or the at least one secondary player terminal.

3. Apparatus for playing a game as claimed in claim 1, wherein:
the at least one secondary player terminal further comprises communication apparatus for communication with the game control device or game controller and/or the at least one primary player terminal.

4. Apparatus for playing a game as claimed in claim 1 wherein:
the at least one primary player terminal does not comprise a game play opt-in and/or opt-out selection apparatus and/or input device.

5. Apparatus for playing a game as claimed in claim 1 wherein:
the at least one secondary player terminal does not comprise a game play starting apparatus and/or input device.

6. Apparatus for playing a game as claimed in claim 1 wherein:
the at least one primary player terminal does not enable a game play opt-in and/or opt-out selection in or during a turn of play.

7. Apparatus for playing a game as claimed in claim 1 wherein:
the at least one secondary player terminal does not enable a game play starting function in or during a turn of play.

8. Apparatus for playing a game as claimed in claim 1 wherein:
the at least one primary player terminal and the at least one secondary player terminal each comprise a player terminal configurable either as a primary player terminal or as a secondary player terminal in each turn of play for that turn of play.

9. Apparatus for playing a game as claimed in claim 8 wherein:
each player terminal configurable either as a primary player terminal or as a secondary player terminal in each turn of play for that turn of play are configured and remain as either as a primary player terminal or as a secondary player terminal in each turn of play for that turn of play.

10. Apparatus for playing a game as claimed in claim 8 wherein the configuration of each player terminal either as a primary player terminal or as a secondary player terminal in each turn of play for that turn of play is effected by, or under the control of, the game control device or game controller.

11. Apparatus for playing a game as claimed in claim 10 wherein the configuration of each player terminal as either as a primary player terminal or as a secondary player terminal in each turn of play for that turn of play effected by the game control device or game controller is determined or actioned following an input by a first player via a player terminal.

12. Apparatus for playing a game as claimed in claim 1 wherein:
the game control device or game controller and/or the at least one primary player terminal and/or the at least one secondary player terminal comprise electronic processing means and/or data storage.

13. Apparatus for playing a game as claimed in claim 1 further comprising apparatus and/or an input/output device for receiving and making payments or credits.

14. Apparatus for playing a game as claimed in claim 1 wherein each player terminal comprises apparatus and/or an input/output device for receiving and making payments or credits.

15. Apparatus for playing a game as claimed in claim 1 wherein each player terminal comprises apparatus and/or an input/output device for placing a stake in each turn of play.

16. Apparatus for playing a game as claimed in claim 1 wherein one or more of the player terminals comprises the game control device or game controller.

17. Apparatus for playing a game as claimed in claim 1 wherein only the primary player terminal of a group comprising at least one primary player terminal and at least one secondary player terminal comprises apparatus and/or an input/output device operable by the primary player in a turn of play to interactively play a game in that turn of play.

18. Apparatus for playing a game as claimed in claim 1 wherein only the secondary player terminal of a group comprising at least one primary player terminal and at least one secondary player terminal comprises apparatus and/or an input/output device operable by the secondary player(s) to opt-in and/or opt-out of a turn of play.

19. Apparatus for playing a game as claimed in claim 1 wherein the at least one primary player terminal and at least one secondary player terminal each comprise apparatus and/or an input/output device operable to place a stake in a turn of play.

20. Apparatus for playing a game as claimed in claim 1, wherein the game control device or game controller comprises a randomiser.

21. Apparatus for playing a game as claimed in claim 1, further comprising:
at least one randomiser for generating one or more random indicia from a predefined set of indicia in a turn of play; and
evaluation means for:
determining which of the primary and secondary player terminals has or have been selected for play in a turn of play and comprise a game entry;
determining if the one or more random indicia generated by the at least one randomiser in a turn of play has or have been validly selected for play and is a winning game entry; and
awarding a winning payment or credit to the player of a winning game entry.

22. Apparatus for playing a game as claimed in claim 1, further comprising:
in each turn of play:
a primary player using the primary player terminal comprising a game play starting apparatus and/or input device; and
a second player(s) using the secondary player terminal(s) comprising a game play opt-in and/or opt-out selection apparatus and/or input device;
the first player selecting one or more games for play in that turn of play, whereafter:
the second player(s) opts in or out of that turn of play of the game by the first player.

23. Apparatus for playing a game as claimed in claim 22, further comprising:
in each turn of play:
the first player placing a stake for the one more games for play in that turn of play; and
where the second player(s) has opted in to that turn of play, the second player(s) places a stake for the one more games for play in that turn of play of the game by the first player.

24. Apparatus for playing a game as claimed in claim 1, wherein the primary and secondary player terminals are located in close proximity.

25. Apparatus for playing a game as claimed in claim 1, wherein the primary and secondary player terminals are located remotely from each other and communication with the game control device or game controller and/or one another is effected via a network such as an intranet, the Internet, or Wi-Fi.

26. Apparatus for playing a game as claimed in claim 1, wherein any one or more of the at least one primary player terminal and at least one secondary player terminal comprises any one or more of a computer, a laptop, a tablet, a personal digital assistant (PDA), a cellular telephone, a smart phone, a television, a visual display unit or other electronic processing means.

27. Apparatus for playing a game as claimed in claim 1, wherein the game control device or game controller comprises any one or more of a computer, a laptop, a tablet, a personal digital assistant (PDA), a cellular telephone, a television, a visual display unit or other electronic processing means.

28. Apparatus for playing a game as claimed in claim 1, wherein any one or more of the at least one primary player terminal and at least one secondary player terminal comprises the game control device or game controller.

29. Apparatus for playing a game as claimed in claim 1 for use in an automated game of chance.

30. Apparatus for playing a game as claimed in claim 1 for use in an automated game of chance where a stake is placed.

31. Apparatus for playing a game as claimed in claim 1 for use in a fruit machine format.

32. Apparatus for playing a game as claimed in claim 1 for use in the game of Roulette.

33. Apparatus for playing a game as claimed in claim 1 for use in a card game.

34. Apparatus for playing a game as claimed in claim 1 for use in the game of Blackjack.

35. Apparatus for playing a game comprising:
a game control device, a game controller or a game control unit; and
at least two player terminals, each player terminal comprising capability for communication with the game control device, game controller or game control unit and/or another player terminal, wherein:
one and only one of the at least two player terminals, where there is only one primary player terminal, is a primary player terminal comprising a game play starting means; and
the or each and every other of the at least two player terminals, where there is only one primary player terminal, is a secondary player terminal comprising a game play opt-in and/or opt-out selection means.

36. (canceled)

37. (canceled)
